(19) United States
(12) Patent Application Publication
(10) Pub. No.: US 2012/0203496 A1
(43) Pub. Date: Aug. 9, 2012

(54) ACCELERATION DETECTING DEVICE, ELECTRONIC APPARATUS, PEDOMETER, AND PROGRAM

(76) Inventor: Satoshi SAKAI, Chiba-shi (JP)

(21) Appl. No.: 13/362,296

(22) Filed: Jan. 31, 2012

(30) Foreign Application Priority Data
Feb. 3, 2011 (JP) 2011-021432

(51) Int. Cl. G06F 19/00; G01C 22/00

(52) U.S. Cl. 702/141

(57) ABSTRACT

An acceleration detecting device operable in a power-saving mode, including an acceleration detecting section for detecting acceleration in a first direction and a second direction independent from the first direction. The device includes a sampling period reducing section for reducing a sampling period used for detecting the acceleration in the first direction when the magnitude of the acceleration in the first direction exceeds a predetermined value.

### BACKGROUND OF THE INVENTION

1. Field of the Invention

The present invention relates to an acceleration detecting device, an electronic apparatus, a pedometer, and a program.

2. Description of the Related Art

As a result of recent advances in the field of acceleration sensors, more people are getting familiar with electronic apparatus having an acceleration sensor. Patent Document 1 disclosures a portable electronic apparatus which detects acceleration imparted thereto to determine whether a predetermined motion has been imparted to the electronic apparatus based on positive and negative changes in the acceleration. The apparatus performs a predetermined operation based on the result of the determination.

Patent Document 1: JP-A-2008-33526

Acceleration is imparted to the portable electronic apparatus disclosed in Patent Document 1 as a result of a “shake operation” that is an operation of imparting an instantaneous force such as resetting the reading of a mercury thermometer. The apparatus detects positive and negative changes in acceleration which occur in a short period of time. Therefore, the portable electronic apparatus disclosed in Patent Document 1 has a short acceleration sampling period, and the apparatus has the problem of high power consumption.

### SUMMARY OF THE INVENTION

It is an aspect of the present application to provide an acceleration detecting device, an electronic apparatus, a pedometer, and a program which allow electric power to be saved.

(1) According to another aspect of the present application, there is provided an acceleration detecting device including an acceleration detecting section for detecting acceleration in a first direction and a second direction independent from the first direction. The acceleration detecting device is characterized in that it includes a sampling period reducing section for reducing a sampling period used for detecting the acceleration in the first direction when the magnitude of the acceleration in the first direction exceeds a predetermined value.

(2) According to another aspect of the present application, there is provided an acceleration detecting device according to the item (1), characterized in that it includes a display section for displaying information on a display surface thereof and in that the first direction is perpendicular to the display surface of the display section.

(3) According to another aspect of the present application, there is provided an acceleration detecting device according to the item (1), characterized in that it includes an impact determining section for determining whether there has been an impact or not based on the acceleration in the first direction and a sampling period extending section for returning the sampling period of the acceleration sensor to the initial value after it is determined by the impact determining section that there has been an impact.

(4) There is provided an acceleration detecting device characterized in that it includes an impact determining section for determining whether there has been an impact or not based on the acceleration in the first direction and a step determining section for determining whether there has been a step of the user or not based on the acceleration in the first direction.

(5) According to another aspect of the present application, there is provided an acceleration detecting device, characterized in that the step determining section determines whether there has been a step of the user or not based on the acceleration in the second direction.

(6) According to another aspect of the present application, there is provided an electronic apparatus including an acceleration detecting device according to any of the items (1) to (5).

(7) According to another aspect of the present application, there is provided a pedometer including an acceleration detecting device according to any of the items (1) to (5).

(8) According to another aspect of the present application, there is provided a program for causing a computer of an acceleration detecting device including an acceleration detecting section for detecting acceleration in a first direction and a second direction independent from the first direction to execute the step of reducing a sampling period used for detecting the acceleration in the first direction when the magnitude of the acceleration in the first direction exceeds a predetermined value.

According to the present application, electric power can be saved.

### BRIEF DESCRIPTION OF THE DRAWINGS

FIG. 1 is an illustration of the appearance of a pedometer according to an embodiment of the invention;

FIG. 2 is a schematic block diagram of the pedometer of the embodiment;

FIG. 3 is an illustration showing directions of acceleration detected by the pedometer of the embodiment when the user is walking while watching a display section;

FIG. 4 is a graph showing composite values of acceleration signal detected by the pedometer of the embodiment when the user is walking;

FIG. 5 is a graph showing an example of acceleration in a direction along a Z axis observed when an impact is imparted to the pedometer of the embodiment; and

FIG. 6 is a flow chart showing exemplary operations of the pedometer of the embodiment.

### DETAILED DESCRIPTION OF THE INVENTION

An embodiment of the invention will now be described in detail with reference to the drawings. A pedometer will be described as an exemplary electronic apparatus according to the present embodiment.

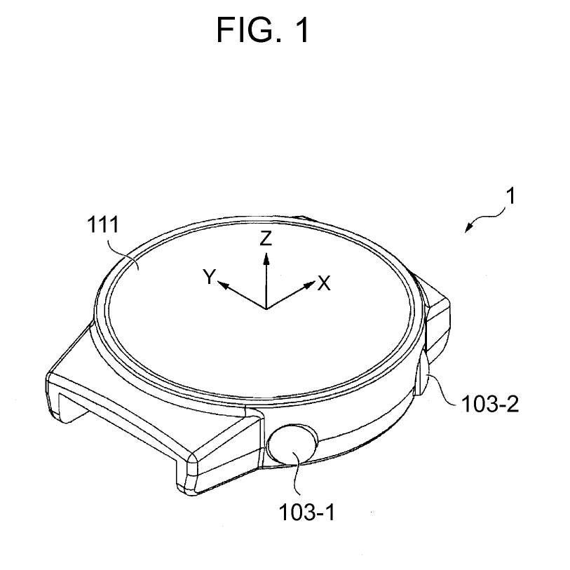

FIG. 1 is an illustration of the appearance of a pedometer 1 according to the present embodiment of the invention. The pedometer 1 is a wrist watch type pedometer which is worn on the back side of a user's wrist to be used by the user. The pedometer 1 of the illustrated embodiment includes a display section 111 provided on a top surface of the body thereof and input sections 103-1 and 103-2 provided on sides of the body. The display section 111 has a display surface on which a step count and the like are displayed. The input sections 103-1 and 103-2 accept a user's inputs for starting and stopping the pedometer and for measuring lap times in a stop watch mode. In the present embodiment, it is assumed that the plane on which the display section 111 of the pedometer 1 lies constitutes an XY plane and that the direction perpendicular to the display surface of the display section 111 constitutes the Z direction.

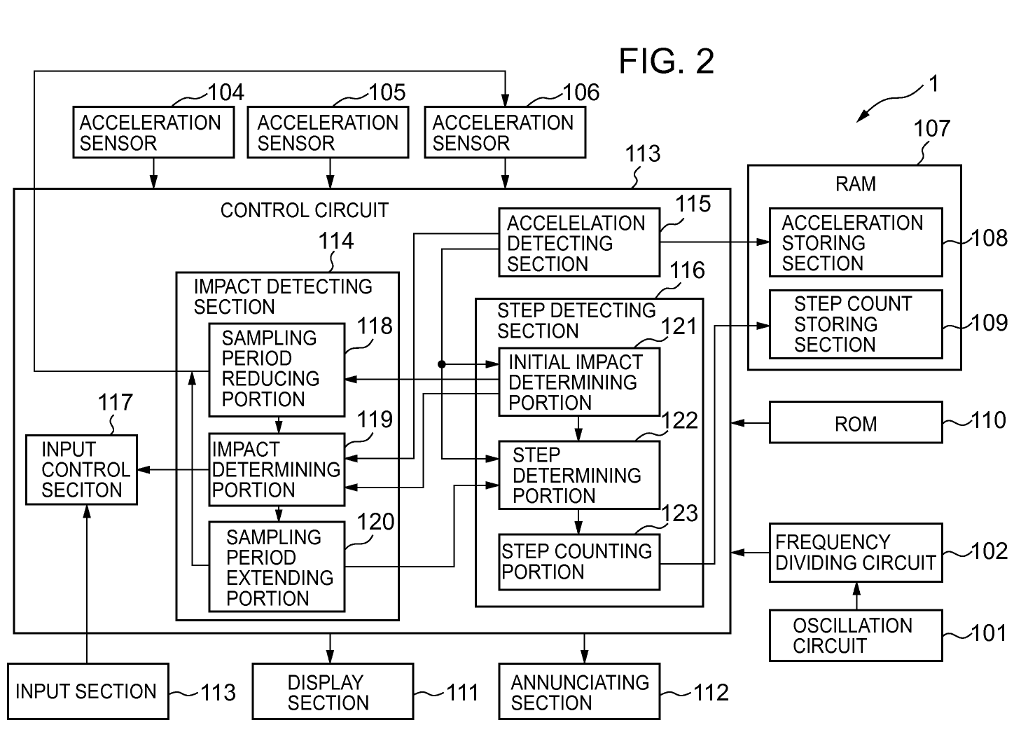

FIG. 2 is a schematic block diagram showing a configuration of the pedometer 1 according to the present embodiment. Referring to FIG. 2, the pedometer 1 includes an oscillation circuit 101, a frequency dividing circuit 102, input sections 103 (input sections 103-1 and 103-2 shown in FIG. 1), an acceleration sensor 104 (for the X direction), an acceleration sensor 105 (for the Y direction), an acceleration sensor 106 (for the Z-direction) which may be referred to as a first acceleration sensor, a RAM (Random Access Memory) 107, an acceleration storing section 108, a step count storing section 109, a ROM (Read Only Memory) 110, a display section 111, an annunciating section 112, and a control circuit 113. The control circuit 113 includes an impact detecting section 114, an acceleration detecting section 115, a step detecting section 116, and an input control section 117. The impact detecting section 114 includes a sampling frequency reducing portion 118, an impact determining portion 119, and a sampling period extending portion 120. The step detecting section 116 includes an initial impact determining portion 121, a step determining portion 122, and a step counting portion 123.

The oscillation circuit 101 generates a signal having a predetermined frequency. The frequency dividing circuit 102 performs frequency division of the signal generated by the oscillation circuit 101 to generate a reference signal to be used for operations of the control circuit 113.

The input section 103 accepts various inputs from a user. For example, it accepts inputs for starting and stopping various functions of the pedometer 1, an input for setting a time in a clock, and an input for setting the clock to alarm.

Acceleration sensors 104 to 106 detect X-, Y-, and Z-components (a direction along the Z-axis will be referred to as “first direction”, and a direction along the X-axis or Y-axis will be referred to as “second direction”) of acceleration of the pedometer 1, respectively, the components being orthogonal to each other in a rectangular coordinate system shown in FIG. 1. The acceleration sensor 104 detects acceleration in a direction along the X-axis. The acceleration sensor 105 detects acceleration in a direction along the Y-axis. The acceleration sensor 106 detects acceleration in a direction along the Z-axis. The acceleration sensors 104 to 106 output acceleration signals representing detected acceleration to the impact determining portion 119, the initial impact determining portion 121, and the step determining portion 122.

When a period reduction instruction is input from the sampling period reducing portion 118, the acceleration sensor 106 sets a sampling period (for example, 50 ms) shorter than a sampling period (for example, 80 ms) which is normally used for detecting steps of a user according to the present embodiment. When a period expansion instruction is input from the sampling period extending portion 120, the acceleration sensor 106 sets a sampling period (for example, 80 ms) longer than a sampling period which has been set in response to the input of a period reduction instruction from the sampling period reducing portion.

Data to be temporarily saved are written or stored by the control circuit 113 in the RAM 107. Temporarily saved data in the RAM 107 are read out by the control circuit 113.

The data of acceleration represented by an acceleration signal written by the acceleration detecting section 115 are stored in the acceleration storing section 108 of the RAM 107. A step count written by the step counting portion 123 is stored in the step count storing section 109.

Programs to be executed by the control circuit 113 are stored in the ROM 110. The programs to be executed by the control circuit 113 are read out from the ROM 110 to the control circuit 113.

Information such as a step count and time is input from the control circuit 113 to the display section 111, and the information such as a step count and time is displayed on the display surface of the display section.

A signal for issuing an annunciating tone such as an alarm is input from the control circuit 113 to the annunciating section 112, and the section 112 issues an annunciating tone such as an alarm.

The control circuit 113 is a CPU (Central Processing Unit) which performs operations such as detection of acceleration, impact, and steps of the user.

When a signal indicating that there has been an initial is input from the initial input determining portion 121 to the impact detecting section 114 of the control circuit 113, the detecting section performs impact determination. Details of the impact determination will be described later.

The acceleration detecting section 115 performs A-D conversion of the acceleration signals input from the acceleration sensors 104 to 106 to generate acceleration signals which are digital signals. The acceleration detecting section 115 writes information represented by the X-, Y-, and Z-axial (or tri-axial) acceleration signals thus generated in the acceleration storing section 108 and outputs the acceleration signals to the initial impact determining portion 121, the impact determining portion 119, and the step determination portion 122. Alternatively, the acceleration detecting section 115 may output only the Z-axial acceleration signal to the initial impact determining portion 121.

The step detecting section 116 detects steps of the user based on the acceleration signals input from the acceleration detecting section 115. Details of step detection will be described later.

The input control section 117 controls signals input to the pedometer 1 for enabling a clock function and the like, based on inputs from the input section 103 or the impact determining portion 119.

When an initial impact detection signal indicating that there has been an initial behavior of an impact is input from the initial impact determining portion 121, the sampling period reducing portion 118 outputs a period reduction instruction to the acceleration sensor 106 to instruct it to change (reduce) the sampling period for acceleration measurement to a period (for example, 50 ms) than a period (for example, 80 ms) which is normally used for detecting steps of a user.

The impact determining portion 119 determines whether there has been an impact or not based on changes which occurred in acceleration signals input from the acceleration detecting section 115 as time passed. Details of operations of the impact determining portion 119 will be described later. When it is determined there has been an impact, the impact determining portion 119 outputs a signal indicating that there has been an impact to the input control section 117 ad the sampling period extending portion 120.

Based on the signal input from the impact determining portion 119 indicating that there has been an impact, the sampling period extending portion 120 outputs a period extension instruction instructing a change to a longer period (for example, 80 ms). That is, the shorter sampling period which has been used for sampling for determining whether there has been an impact or not is returned (extended) to the initial sampling period which is normally used for detecting steps of a user. Steps of the user can be satisfactorily detected at the extended sampling frequency.

The initial impact determining portion 121 detects an initial behavior of an impact based on the acceleration signals input from the acceleration detecting section 115. Details if the initial impact determining portion 121 will be described later. When an initial behavior of an impact is detected, the initial impact determining portion 121 outputs an initial impact detection signal indicating that there has been an initial behavior of an impact to the sampling period reducing portion 118.

The step determining portion 122 makes determination on whether there has been steps of the user or not (referred to as “step determination”) based on changes over time in the acceleration signals input from the acceleration detecting section 115. When it is determined that there has been steps of the user, a step detection signal indicating that there has been steps of the user is output to the step counting portion 123.

The step counting portion 123 counts the number of steps of the user based on the step detection signal input from the step determining portion 122 and stores a resultant step count in the step count storing section 109.

The acceleration signals detected by the acceleration sensors of the pedometer 1 will now be described. A user who wears the wrist watch type pedometer 1 swings his or her arms back and forth while walking in a normal manner. Therefore, when the user walks in a normal manner, components of the acceleration signals on an XY plane as defined in FIG. 1 have relatively great values, and a Z-component of the signals has a relatively small value. When the user walks while watching the display screen 111, the Z-component of the acceleration signals has a relatively great value, and the components on the XY plane have relatively small values.

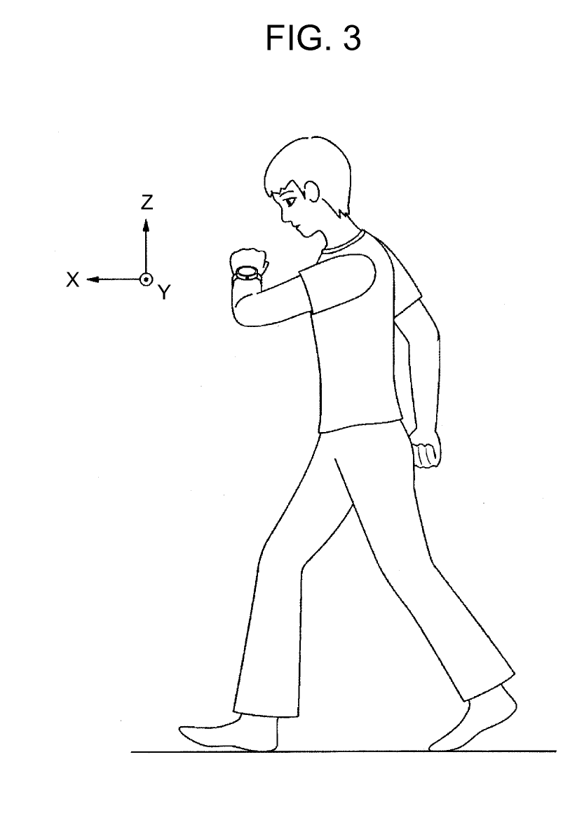

FIG. 3 is a schematic illustration of an exemplary state of the pedometer 1 in use. In the illustrated example, the pedometer 1 is worn around an arm of a user. The user is walking while watching the display surface 111. The user bends the arm to watch the display surface 111. Therefore, the pedometer 1 moves greatly in a direction along the Z-axis and moves not so much in directions along the X- and Y axes. That is, acceleration signals are obtained, including a Z-component having a relatively great value and components on the XY plane having relatively small values.

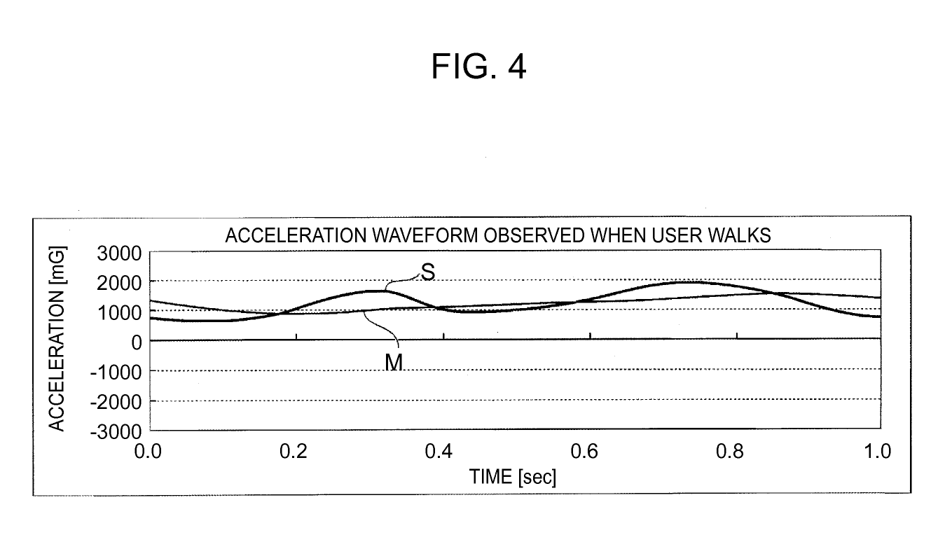

FIG. 4 is a graph showing composite values of acceleration detected by the pedometer 1 when the user is walking. The line indicated by the character S is an exemplary waveform representing composite values of acceleration indicated by acceleration signals obtained when the user is walking. Specifically, when acceleration in a direction along the X axis, acceleration in a direction along the Y axis, and acceleration in a direction along the Z axis are represented by X, Y, and Z, respectively, the step determining portion 122 calculates a composite value of acceleration signals using Expression 1 shown below.

(X̂2+Ŷ2) ̂0.5+Z Expression 1

The line indicated by the character M is a waveform representing moving averages of the waveform S.

The step determining portion 122 determines whether the user has walked based on the waveforms S and M. Specifically, the step determining portion 122 determines that the user has walked when it detects a point at which the waveform S crosses the waveform M as it extends downward. Alternatively, the step determining portion 122 may determine that the user has walked when it detects a point at which the waveform S crosses the waveform M as it extends upward. The step determining portion 122 may calculate a composite value of acceleration signals using Expression 2 shown below.

(X̂2+Y ̂2) ̂0.5+|Z| Expression 2

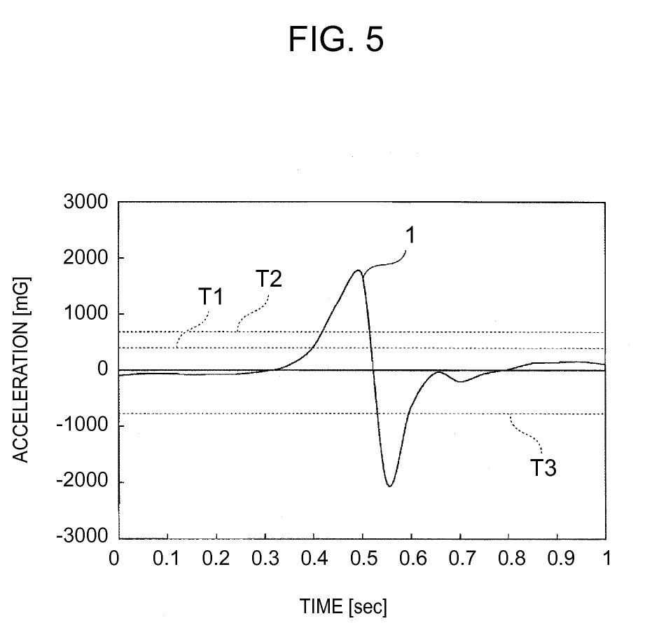

FIG. 5 is a graph showing an example of acceleration in a direction along the Z axis observed when an impact is imparted to the pedometer 1. In the illustrated example, the horizontal axis of the graph represent time, and the vertical axis represents acceleration (mG). The line indicated by the character I represents a Z-axial component of the acceleration measured when the pedometer 1 is worn by a user as shown in FIG. 3. The lines indicated by reference numerals T1, T2, and T3 represent thresholds for acceleration used for impact determination. The line indicated by the reference numeral T1 represents a first threshold which is 500 mG in this example. The line indicated by the reference numeral T2 represents a second threshold which is 750 mG in this example. The line indicated by the reference numeral T3 represents a third threshold which is −750 mG in this example.

FIG. 5 shows an exemplary acceleration waveform I observed when an impact is imparted to the pedometer 1 by hitting a part of a user's arm around which the pedometer 1 is worn against a part of the body around the belly or waist. In the present embodiment, an input to the pedometer 1 is accepted by detecting an impact imparted by a motion of a user as thus described.

The waveform I indicates that the pedometer 1 has substantially zero acceleration before it receives an impact (for example, during the period from 0 to 0.2 sec). Acceleration of the pedometer 1 acts in a positive direction along the Z axis at the initial stage of an impact (for example, during the period from 0.3 sec. to 0.45 sec.). After the acceleration assumes a maximum value (at a time near 0.5 sec.), the acceleration quickly increases in a negative direction along the Z axis. After the acceleration assumes a minimum value (at a time near 0.57 sec.), the acceleration returns to a value near 0.

An exemplary acceleration waveform I observed when a part of a user's arm around which the pedometer 1 is worn is hit against a part of the body around the belly or waist has been described. Even when the user has no intention of inputting something to the pedometer 1 in the form of an impact, the acceleration waveform I may exceed the first threshold indicated by the reference numeral T1 as a result of a movement of the part of the arm around which the pedometer 1 is worn. In such a case, although the initial impact determining portion 121 detects an initial behavior of an impact, the impact determining portion 119 does not determine that there has been an impact because conditions for impact determination are not satisfied.

An acceleration waveform I resulting from an impact imparted to the pedometer when it is hit against an object other than the user extends in the positive and negative directions in a pattern that is the reverse of the pattern shown in FIG. 5. Since the criteria for impact determination are not satisfied, the impact determining portion 119 does not determine that there has been an impact. It is therefore possible to prevent the impact from being mistaken for an input of an impact switch.

When the user wears the wrist watch type pedometer 1 on the palm side of the arm instead of the back side thereof, a Z axis component of acceleration observed in such a state has positive and negative signs which are the reverse of those shown in FIG. 5, and the thresholds T1 to T3 will also have the reverse positive and negative signs. In this case, an impact determination process is carried out differently from the process carried out when the pedometer 1 is worn on the back side of the arm. Details of the thresholds and impact determination in such a case will be described later.

The step detecting section 116 and the impact detecting section 114 determine an impact utilizing the characteristics of the waveform of acceleration in the directions along the Z axis. Specifically, it is determined that there has been an initial behavior of an impact when the acceleration signal indicated by the character I in FIG. 5 extends in the positive direction along the Z-axis across the threshold T1. Alternatively, such a determination may be made when the inclination of the acceleration signal exceeds a predetermined threshold rather than when the acceleration signal extends in the positive direction along the Z-axis across the threshold T1.

A comparison between the waveforms shown in FIGS. 4 and 5 indicates that the waveform characteristic of an impact shown in FIG. 5 disappears in a shorter time compared to the acceleration waveform shown in FIG. 4. The initial impact determining portion 121 detects a Z component of acceleration input from the acceleration detecting section 115. When the Z component of the acceleration thus detected is greater than the first threshold, a signal indicating that there has been an initial behavior of an impact is output to the sampling period reducing section 118. Thus, the sampling period used by the acceleration sensor 106 of the pedometer 1 can be made shorter than the period used for determining a step walked by the user. Thus, an impact can be reliably determined. For example, a change is made in the pedometer 1 such that sampling will take place at intervals of 50 ms whereas sampling has taken place at intervals of 80 ms when detecting steps of the user.

The Z component of the acceleration signal is input from the acceleration detecting section 115 to the impact determining portion 119. The impact determining portion 119 determines that there has been an impact when both of two conditions are satisfied within a predetermined period of time (e.g., 250 ms) or when the value of the Z component of the input acceleration signal becomes greater than the second threshold (condition A) and the value thereafter becomes smaller than the third threshold (condition B).

After determining that there has been an impact, the impact determining portion 119 outputs an instruction to the sampling period extending portion 120 to return (extend) the sampling period to the initial value. The sampling period extending portion 120 outputs an instruction to the acceleration sensor 106 to cause it to return the acceleration sampling period to the initial value. Thus, the sampling period of the pedometer 1 which has been set by the sampling period reducing portion 118 at, for example, 50 ms as a result of detection of an initial behavior of an impact by the initial impact determining portion 121 is returned to 80 ms by the sampling period extending portion 120.

Operations of the pedometer 1 of the present embodiment will now be described.

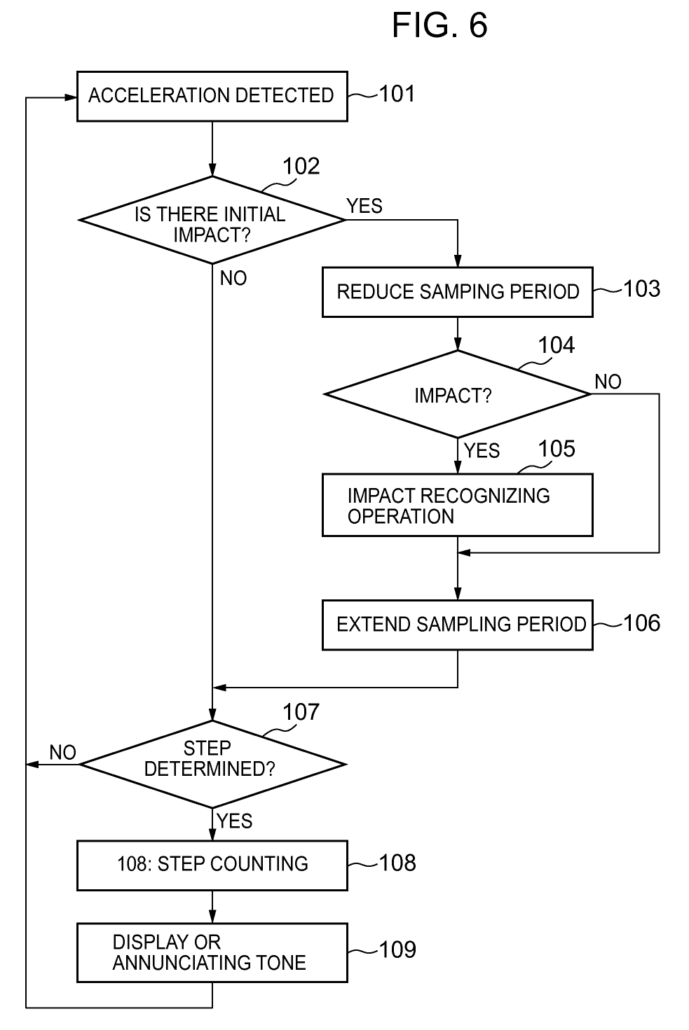

FIG. 6 is a flow chart showing exemplary operations of the pedometer 1 of the present embodiment.

At step S101, the acceleration detecting section 115 outputs an instruction to cause the acceleration sensors 104 to 106 to detect acceleration. The acceleration sensors 104 to 106 output X-, Y-, and X-axial components of acceleration imparted to the pedometer 1 to the acceleration detecting section 115. Thereafter, the flow proceeds to step S102.

At step S102, the acceleration detecting section 115 outputs the Z-axial component of the acceleration to the initial impact determining portion 121. The initial impact determining portion 121 determines whether the value of the Z-axial component of acceleration input from the acceleration detecting section 115 is greater than the first threshold or not. When it is determined that the value of the Z-axial component of acceleration is greater than the first threshold (If yes), the flow proceeds to step S103. When it is not determined that the value of the Z-axial component of acceleration is greater than the first threshold (If no), the flow proceeds to step S107.

At step S103, the sampling period reducing portion 118 outputs a period reduction instruction to the acceleration sensor 106. When the period reduction instruction is input, the acceleration sensor 106 reduces the sampling period. For example, the sampling period which is normally set at 80 ms is changed to 50 ms. Thereafter, the flow proceeds to step S104.

At step S104, the Z component of the acceleration signal is input from the acceleration detecting section 115 to the impact determining portion 119. The impact determining portion 119 determines that there has been an impact when the value of the Z component of the input acceleration signal becomes greater than a second threshold and thereafter becomes smaller than the third threshold within a predetermined period of time (e.g., 250 ms). When it is determined that there has been an impact (Yes), the flow proceeds to step S105. When it is determined that there has been no impact (No), the flow proceeds to step S106.

At step S105, the control circuit 113 controls various functions of the pedometer 1. For example, when the pedometer 1 has a stop watch function, the control circuit stores the time measured by the stop watch when an impact occurred in the RAM 107 as a lap time. The control circuit 113 may start and stop the stop watch or change the mode of display. Thereafter, the flow proceeds to step S106.

At step S106, the sampling period extending portion 120 outputs a period extension instruction to the acceleration sensor 106. When the period extension instruction is input, the acceleration sensor 106 extends the sampling period. For example, the sampling period is changed from 50 ms to 80 ms. Thereafter, the flow proceeds to step S107.

At step S107, the step determining portion 122 determines whether the user has walked or not based on the acceleration signal input from the acceleration detecting section 115. When it is determined that the user has walked (Yes), the flow proceeds to step S108. When it is determined that the user has not walked (No), the flow returns to step S101.

At step S108, the step counting portion 123 reads the present step count from the step count storing section 109. The step counting portion 123 adds “1” to the present step count read from the step count storing section 109 and writes the resultant value in the step count storing section 109.

At step S109, the display section 111 displays the updated step count read from the step count storing section 109. The annunciating section 112 issues an annunciating tone when a preset step count is reached.

As thus described, when the magnitude of acceleration in a direction along the Z axis exceeds a predetermined value, the sampling period reducing portion 118 of the present embodiment reduces the sampling period used for detecting the acceleration in the direction along the Z axis. Thus, the pedometer 1 of the present embodiment reduces the sampling period when a change in acceleration at the initial stage of an impact (an initial behavior of an impact) is detected. It is therefore possible to reliably detect an impact which results in an abrupt change in acceleration compared to a normal step of a user. On the contrary, when a change in acceleration as encountered at the initial stage of an impact is not detected or when there is no impact attributable to an impact, the frequency of sampling can be reduced to achieve power saving.

The present embodiment includes the display section 111 for displaying information, and a direction along the Z axis is perpendicular to the display surface of the display section ill. Therefore, the pedometer 1 can accurately detect an impact switch because acceleration from which the impact is to be detected acts in substantially the same direction as the direction of the user's operation of inputting the impact switch.

In the present embodiment, the impact determining portion 119 determines an impact base on acceleration in a direction along the Z axis. When an impact is determined by the impact determining portion 119, the sampling period extending portion 120 extends the sampling period of the acceleration sensor 106. Thus, the sampling period of the pedometer 1 can be extended after the input of an impact switch is completed, which allows power to be saved.

The present embodiment has been described as an instance in which the pedometer 1 detects one impact and exercises control according to the impact. The invention is not limited to such an instance, and a plurality of impacts may be detected, and control may be exercised according to the number of impacts. For example, when it is determined that there has been an impact (or when it is not determined there has been an impact within a predetermined period of time after the presence of an impact is once determined) while the pedometer 1 is measuring time using the stop watch function, the time measured by the stop watch function when the impact occurred is stored in the RAM 107 as a lap time. When it is determined that there has been two impacts (or when it is determined there has been an impact within a predetermined period of time after the presence of an impact is once determined), the time of the stop watch is stopped.

The present embodiment has been described as an instance in which the sampling period of the pedometer 1 is returned to the initial value by the sampling period extending portion 120 immediately after an impact is detected by the impact determining portion 119. However, the invention is not limited to such an instance, and the time interval spent before the initialization of the sampling period may be extended. For example, such a time interval to be spent by the pedometer 1 may be determined based on the number of impacts imparted thereto. When control in the pedometer 1 is to be exercised based on a determination that there has been n impacts, the time for initializing the sampling period is extended to a time interval sufficient to detect n-1 impacts. Thus, the pedometer 1 can reliably detect a switching operation even when controlled is exercised based on the fact that a plurality of impacts have been received.

In the present embodiment, it may be determined that there has been an initial behavior of an impact when it is determined at step S102 shown in FIG. 6 that the value of a Z-axis component of acceleration increases at a rate higher than a predetermined rate.

The functions of various parts of the pedometer 1 of the above-described embodiment may be entirely or partially implemented by recording programs for implementing the functions in a computer readable recording medium and reading the programs recorded in the recording medium into a computer system to have the programs executed. The “computer system” in this context may be an operating system or hardware such as a peripheral apparatus.

The “computer readable recording medium” may be a portable medium such as a flexible disk, a magneto-optical disk, a ROM, or a CD-ROM or a storage device such as a hard disk incorporated in a computer system. Further, the “computer readable recording medium” may be a medium for holding programs dynamically for a short time, e.g., a communication line for transmitting programs through a network such as the internet or a communication network such as a telephone network. In such a case, the medium may include a medium for holding the programs temporarily such as a volatile memory in a computer system to serve as a server or client. The programs may implement only a part of the above-described functions. Further, the programs may implement the above-described functions in combination with programs which have already been recorded in a computer system.

An embodiment of the present invention has been described above in detail with reference to the drawings. The invention is not limited to the specific configuration described above, and various design changes may be made without departing from the spirit of the invention.

What is claimed is:

1. An acceleration detecting device including an acceleration detecting section for detecting acceleration in a first direction and a second direction independent from the first direction, the device comprising:
a sampling period reducing section for reducing a sampling period used for detecting the acceleration in the first direction when the magnitude of the acceleration in the first direction exceeds a predetermined value.

2. An acceleration detecting device according to claim 1, comprising a display section for displaying information on a display surface thereof, wherein the first direction is perpendicular to the display surface of the display section.

3. An acceleration detecting device according to claim 1, comprising:
an impact determining section for determining whether has been an impact or not based on the acceleration in the first direction; and
a sampling period extending section for returning the sampling period of the acceleration sensor to the initial value after it is determined by the impact determining section that there has been an impact.

4. An acceleration detecting device according to claim 2, comprising:
an impact determining section for determining whether has been an impact or not based on the acceleration in the first direction; and
a sampling period extending section for returning the sampling period of the acceleration sensor to the initial value after it is determined by the impact determining section that there has been an impact.

5. An acceleration detecting device according to claim 1, comprising:
an impact determining section for determining whether there has been an impact or not based on the acceleration in the first direction; and
a step determining section for determining whether there has been a step of the user or not based on the acceleration in the first direction.

6. An acceleration detecting device according to claim 2, comprising:
an impact determining section for determining whether there has been an impact or not based on the acceleration in the first direction; and
a step determining section for determining whether there has been a step of the user or not based on the acceleration in the first direction.

7. An acceleration detecting device according to claim 3, comprising:
an impact determining section for determining whether there has been an impact or not based on the acceleration in the first direction; and
a step determining section for determining whether there has been a step of the user or not based on the acceleration in the first direction.

8. An acceleration detecting device according to claim 4, comprising:
an impact determining section for determining whether there has been an impact or not based on the acceleration in the first direction; and
a step determining section for determining whether there has been a step of the user or not based on the acceleration in the first direction.

9. An acceleration detecting device according to claim 5, wherein the step determining section determines whether there has been a step of the user or not based on the acceleration in the second direction.

10. An acceleration detecting device according to claim 6, wherein the step determining section determines whether there has been a step of the user or not based on the acceleration in the second direction.

11. An acceleration detecting device according to claim 7, wherein the step determining section determines whether there has been a step of the user or not based on the acceleration in the second direction.

12. An acceleration detecting device according to claim 8, wherein the step determining section determines whether there has been a step of the user or not based on the acceleration in the second direction.

13. An electronic apparatus comprising an acceleration detecting device according to claim 1.

14. An electronic apparatus comprising an acceleration detecting device according to claim 2.

15. An electronic apparatus comprising an acceleration detecting device according to claim 3.

16. An electronic apparatus comprising an acceleration detecting device according to claim 4.

17. An electronic apparatus comprising an acceleration detecting device according to claim 5.

18. An electronic apparatus comprising an acceleration detecting device according to claim 6.

19. A pedometer comprising an acceleration detecting device according to claim 1.

20. A program for causing a computer of an acceleration detecting device including an acceleration detecting section for detecting acceleration in a first direction and a second direction independent from the first direction to execute the step of reducing a sampling period used for detecting the acceleration in the first direction when the magnitude of the acceleration in the first direction exceeds a predetermined value.
